(19) United States
(12) Patent Application Publication
(10) Pub. No.: US 2008/0003420 A1
(43) Pub. Date: Jan. 3, 2008

(54) TRANSFER HARDCOAT FILMS FOR GRAPHIC SUBSTRATES

(75) Inventors: Robert R. Condon, Woodbury, MN (US); Robert J. Fleming, St. Paul, MN (US); Jeffrey O. Emslander, Afton, MN (US); Richard J. Pokorny, Maplewood, MN (US); William J. Hunt, Afton, MN (US); John P. Baetzold, North St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/427,575

(22) Filed: Jun. 29, 2006

(51) Int. Cl. B32B 27/40; B32B 27/30

(52) U.S. Cl. 428/216; 428/336; 428/339; 428/423.1; 428/522

(57) ABSTRACT

Methods of protecting graphic substrates are disclosed. One method includes coating a hardcoat composition onto a substrate to form a hardcoat layer, curing the hardcoat layer to form a cured hardcoat layer, disposing a thermoplastic layer onto the cured hardcoat layer to form a transparent hardcoat composite film, and laminating the transparent hardcoat composite film onto a graphic substrate with heat and pressure. The thermoplastic layer softens and adheres to the graphic substrate to form a protected graphic substrate. Stain and scratch resistant cured hardcoat composite films are also disclosed.

### BACKGROUND

The present disclosure relates generally to transfer hardcoat films for graphic substrates, and particularly to hardcoat films that are applied to graphic substrates.

Graffiti resistant protection products for the graphics industry consist mainly of films and clear coats that overlay graphic substrates. While these products provide some level of protection to the graphic substrate, they each have limitations. Protective films often fail to provide proper scratch or stain resistance, and/or are often brittle. Clear coats often embrittle the protected film, making removal of the protected film difficult. Improved graffiti resistant protection products are desired.

### SUMMARY

In one exemplary implementation, the present disclosure is directed to a method of protecting a graphic substrate by coating a hardcoat composition onto a substrate to form a hardcoat layer, curing the hardcoat layer to form a cured hardcoat layer, disposing a thermoplastic layer onto the cured hardcoat layer to form a transparent hardcoat composite film, and laminating the transparent hardcoat composite film onto a graphic substrate with heat and pressure. The thermoplastic layer softens and adheres to the graphic substrate to form a protected graphic substrate.

In another exemplary implementation, the present disclosure is directed to a method of protecting a graphic substrate by providing a transparent cured hardcoat composite film having a cured hardcoat layer on a thermoplastic layer. The cured hardcoat layer has a thickness in a range from 1 to 15 micrometers and the thermoplastic layer has a thickness in a range from 0.5 to 5 micrometers. Then, printing an image onto the thermoplastic layer, and laminating the transparent hardcoat composite film onto a graphic substrate with heat and pressure to form a protected graphic substrate. The thermoplastic layer softens and adheres to the graphic substrate.

In another exemplary implementation, the present disclosure is directed to a transparent cured hardcoat composite film including a release liner, a stain and scratch resistant cured hardcoat layer disposed on the release liner, and a thermoplastic layer on the cured hardcoat layer. The cured hardcoat layer has a thickness in a range from 1 to 15 micrometers, and the thermoplastic layer has a thickness in a range from 0.5 to 20 micrometers.

These and other aspects of the transfer hardcoat films according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, in which:

FIG. 1 is a schematic diagram of a transfer hardcoat film article; and

FIG. 2 is a schematic diagram of a protected graphic substrate.

### DETAILED DESCRIPTION

Accordingly, the present disclosure is directed to transfer hardcoat composite films for graphic substrates, and particularly to cured hardcoat films that can be applied to graphic substrates to provide graffiti, scratch resistance and/or conformability. While the present invention is not so limited, an appreciation of various aspects of the invention will be gained through a discussion of the examples provided below.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “polymer” will be understood to include polymers, copolymers (e.g., polymers formed using two or more different monomers), oligomers and combinations thereof, as well as polymers, oligomers, or copolymers that can be formed in a miscible blend.

The term “transparent film” refers to a film having a thickness and when the film is disposed on a substrate, an image (disposed on or adjacent to the substrate) is visible through the thickness of the transparent film. In many embodiments, a transparent film allows the image to be seen through the thickness of the film without substantial loss of image clarity. In some embodiments, the transparent film has a matte or glossy finish.

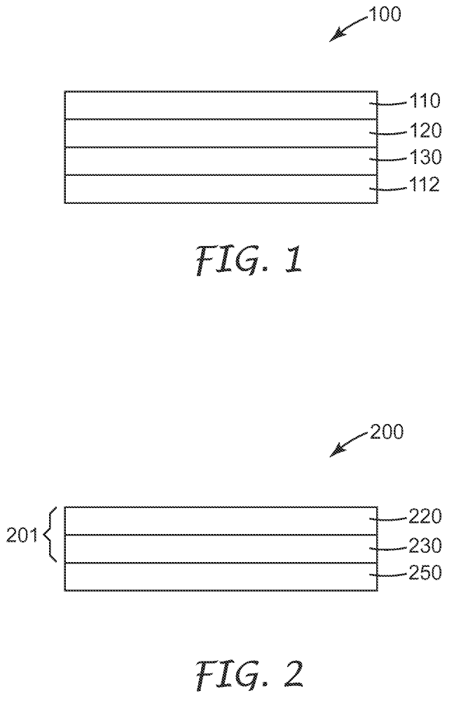

FIG. 1 shows a schematic diagram of one exemplary embodiment of a composite film article 100. The illustrated composite film article 100 includes a stain and scratch resistant cured hardcoat layer 120 disposed between a release liner 110 and a thermoplastic layer 130. In many embodiments, the thermoplastic layer 130 includes an ink receptive or receptor material. In some embodiments, the ink receptive material is incorporated into the thermoplastic layer 130. In other embodiments, an ink receptive layer is disposed on the thermoplastic layer 130. In some embodiments, an image formed from a solvent based ink is disposed on either side of the thermoplastic layer 130 or ink receptive thermoplastic layer 130.

The image described herein can be formed on the thermoplastic layer/ink receptive layer 130 via any useful printing method such as, for example, a solvent based ink jet printing process, a thermal mass transfer printing process, electrostatic printing, gravure printing, offset printing, screen printing, and the like. Solvent based printing processes allow for the image to be formed of a thermoplastic material. This ink can include an organic solvent, a thermoplastic material, and a pigment. The organic solvents can include any organic solvent useful for solubilizing the thermoplastic ink material and includes, for example, ketones, glycol ethers, esters, and the like. The pigment can include any pigment useful for providing color to the ink and are known in the ink jet field.

In some embodiments, another release liner 112 is disposed on the thermoplastic layer 130, but this is not required. In many embodiments, the cured hardcoat layer 120 and the thermoplastic layer 130 have a combined film thickness in a range from 1.5 to 25 micrometers, or from 1.5 to 15 micrometers, or from 1.5 to 10 micrometers.

The thermoplastic layer 130 can include a transparent thermoplastic polymer such as, for example a transparent polyacrylate and derivatives thereof. Other suitable thermoplastic polymers include, but are not limited to, polypropylene, polyacetal, polyamide, polyester, polystyrene, polyvinyl chloride, polyvinylidene chloride, polyurethane, polyurea, and the like. The thickness of the thermoplastic layer 130 can be any useful thickness. In some embodiments, the thermoplastic layer 130 has a thickness of 0.5 to 20 micrometers, or 0.5 to 5 micrometers, or 0.5 to 3 micrometers. In another embodiment, the thermoplastic layer 130 has a thickness of 1 to 3 micrometers.

In some embodiments, the thermoplastic layer 130 can include an ink receptive material or the thermoplastic layer 130 can include an ink receptor layer. An ink receptive layer or material is a layer or material that is receptive to solvent-based ink jet ink. “Solvent-based” means non-aqueous. An ink receptive layer includes a blend of a carrier resin and an ink absorptive resin. The carrier resins described herein are thermoplastic polymers. The carrier resin may be any thermoplastic resin or blend of resins that is compatible with the ink absorptive resin described below.

The ink receptive material is derived from and thus comprises certain urethane-containing polymeric resins. As used herein “base polymer” refers to a single urethane-containing copolymer such as a urethane acrylic copolymer optionally blended with a polyurethane polymer or an acrylic polymer, a blend of at least one polyurethane polymer and at least one acrylic polymer, a blend of at least two polyurethane polymers, and mixtures thereof. Further, the urethane-containing base polymer may optionally be crosslinked. The blend of polymers may form a homogeneous mixture or may be multiphase, exhibiting two or more distinct peaks when analyzed via differential scanning calorimetry (DSC). Further, the ink receptive composition may comprise an interpenetrating network of the base polymer in an insoluble matrix or vice-versa.

In order to achieve good image quality during ink jet printing the printed ink drops spread to within an acceptable range in order to provide complete solid fill of the image. The use of an acrylic polymer alone as an ink receptive layer tends to result in the ink drops not spreading enough, leaving unfilled background areas that contribute to reduced color density and banding defects (i.e. gaps between the rows of ink drops). This is surmised to be due to the good solvent uptake of acrylic polymers. On the other hand, the use of a polyurethane polymer alone tends to result in the ink drops spreading too much resulting in loss of resolution, poor edge acuity, and inter-color bleed occurs in the case of multi-color graphics. This is surmised to be due to insufficient solvent uptake of polyurethane polymers. The ink receptive material described herein exhibits a good balance of ink uptake and color density even though the composition is substantially free of fillers as well as the composition being substantially free of components that are soluble in the solvent of the ink.

The ink receptive coating layer is initially swelled after application of the ink jetted ink. However, after drying (i.e. evaporation of the solvent) the thickness of the ink receptive material is substantially the same as prior to ink application. Although the ink receptive material absorbs the solvent portion of the ink, the binder and colorant of the ink composition tend to remain on the surface of the ink receptive material. Accordingly, at least the urethane portion of the ink receptive coating layer is substantially insoluble in the ink composition (e.g. solvent of the ink).

The ink receptive material includes a urethane containing copolymer. As used herein “copolymer” refers to a polymer having urethane segments and segments of at least one polymeric material that is different than a urethane. In many embodiments, urethane acrylic copolymers include those commercially available from Neoresins Inc., Wilmington, Mass., such as under the trade designation “NeoPac R-9000”. The urethane acrylic copolymer may be employed alone or optionally in combination with at least one polyurethane polymer or at least one acrylic polymer. For use on polyolefin films, it is preferred to employ the NeoPac R-9000 alone or blended with an acrylic resin such as “NeoCryl A-612” at a ratio of about 4:1.

In some embodiments, the ink receptive coatings are preferably derived from a blend comprising at least two polyurethane polymers or at least one polyurethane polymer and at least one acrylic polymer. Aliphatic polyurethanes typically exhibit greater durability, resistance to yellowing, etc. and thus are preferred. Illustrative examples of useful aqueous polyurethane dispersions include those commercially available from Neoresins, Wilmington, Mass. under the trade designations “NeoRez R-960”, “NeoRez R-966”, “NeoRez R-9637”, “NeoRez R-600”, “NeoRez R-650”, “NeoRez R-989” and “NeoRez R-9679”.

The concentration of polyurethane in the ink receptive material generally ranges from about 40 wt-% to about 90 wt-% solids, i.e. the weight of the polyurethane after evaporation of water and/or solvent of the polyurethane emulsion or dispersion relative to the content of the other solid materials in the formulation. Preferably, the amount of polyurethane in the polyurethane/acrylic blend is at least about 50 wt-% and more preferably at least about 60 wt-%.

In other embodiments, ink receptive coatings further include at least one acrylic polymer, the amount of acrylic polymer generally ranges from about 10 wt-% to about 60 wt-% solids. Various acrylic resins are known. A particularly suitable water-based acrylic emulsion is commercially available from Neoresins, Wilmington Mass. under the trade designations “NeoCryl A-612” (reported to have a Konig Hardness of 75 at 144 hours).

Preferred blends comprising a polyurethane polymer and an acrylic polymer include mixtures of NeoRez R-960 and/or NeoRez R-966 (Sward Hardness=30) with Neocryl A-612 (acrylic) wherein the proportion of polyurethane to acrylic is about 2:1. NeoRez R-9679 is also suitable in place of NeoRez R-960 at slightly lower concentrations of polyurethane (e.g. weight ratio of 55/45). The blends just described are particularly preferred for poly(vinyl chloride)-containing films. Another preferred composition, particularly for embodiments wherein the composition is coated onto a polyolefin-containing film includes NeoRez R-600 and NeoCryl A-612 at a ratio of 4:1.

In one embodiment, ink receptive materials include a blend of at least two polyurethane polymers include a mixture of NeoRez R-650 and NeoRez R-989 at a ratio of 9:1. The NeoRez R989 is available from NeoResins in Japan.

The base polymer of the ink receptive material has a solubility parameter, molecular weight, and glass transition temperature (Tg) within a specified range. As used herein, “molecular weight” refers to weight average molecular weight (Mw), unless specified otherwise. In many embodiments, the base polymer and the transparent thermoplastic polymer are formed of the same material and can be the same material.

The solubility parameter of the base polymer of the ink receptive material as well as the ink composition ink jetted onto the coated substrate may vary, typically ranging from about 7 (cal/cm³)^{1/2} to about 12 (cal/cm³)^{1/2}. In some embodiments, the solubility parameter of both the ink and ink receptive material is at least about 8 (cal/cm³)^{1/2} and less than about 10 (cal/cm³)^{1/2}. The solubility of various pure materials, such as solvents, polymers, and copolymers as well as mixtures is known. The solubility parameters of such materials are published in various articles and textbooks. In the present invention, the terminology “solubility parameter” refers to the Hildebrand solubility parameter which is a solubility parameter represented by the square root of the cohesive energy density of a material.

The base polymer has a weight average molecular weight (Mw) as measured by Gas Permeation Chromotography (GPC) of greater than about 60,000 g/mole, or greater than about 80,000 g/mole, or greater than about 100,000 g/mole. Water-borne polymeric materials as well as aqueous dispersions and emulsions often contain polymeric materials having a relatively high Mw, ranging from greater than 400,000 to 1,000,000 or more.

In addition to the previously described solubility parameter and Mw, the base polymer of the ink receptive material ranges in glass transition temperature (Tg), as measured according to Differential Scanning Colorimetry (DSC) from about 30 degrees centigrade to about 95 degree centigrade or from about 50 degrees centigrade to about 80 degrees centigrade. Although the polyurethane alone may have a Tg of less than about 30 degrees centigrade, the presence of the higher Tg acrylic polymer ensures that the Tg of the blend is within the specified range. At a Tg of greater than about 95 degrees centigrade, the solvent of the ink generally does not significantly penetrate into the ink receptive material. These ink receptive materials are disclosed in U.S. Pat. No. 6,881,458 and is incorporated by reference herein, to the extent it does not conflict.

To enhance durability of the ink receptive thermoplastic layer and/or thermoplastic layer, especially in outdoor environments exposed to sunlight, a variety of commercially available stabilizing chemicals can be added. These stabilizers can be grouped into the following categories: heat stabilizers, ultraviolet (UV) light stabilizers, and free-radical scavengers. Heat stabilizers are commercially available from Witco Corp., Greenwich, Conn. under the trade designation “Mark V 1923” and Ferro Corp., Polymer Additives Div., Walton Hills, Ohio under the trade designations “Synpron 1163”, “Ferro 1237” and “Ferro 1720”. Such heat stabilizers can be present in amounts ranging from 0.02 to 0.15 weight percent. UV light stabilizers can be present in amounts ranging from 0.1 to 5 weight percent. Benzophenone type UV-absorbers are commercially available from BASF Corp., Parsippany, N.J. under the trade designation “Uvinol 400”; Cytec Industries, West Patterson, N.J. under the trade designation “Cyasorb UV1164” and Ciba Specialty Chemicals, Tarrytown, N.Y., under the trade designations “Tinuvin 900”, “Tinuvin 123” and “Tinuvin 1130”. Free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation “Tinuvin 292” and Cytec Industries under the trade designation “Cyasorb UV3581”. In general, the ink receptive layer and/or thermoplastic layer can be substantially free of colorant until it is printed with an image. However, it may also contain colorants to provide a uniform background colored film.

The cured hardcoat layer 120 may be made from any suitably curable polymeric material. An example of a suitable material for the cured hardcoat layer 120 is a multi-functional or cross-linkable monomer. Illustrative cross-linkable monomers include multi-functional acrylates, urethanes, urethane acrylates, siloxanes, and epoxies. In some embodiments, cross-linkable monomers include mixtures of multifunctional acrylates, urethane acrylates, or epoxies. In some embodiments, the cured hardcoat layer 120 includes a plurality of inorganic nanoparticles. The inorganic nanoparticles can include, for example, silica, alumina, or zirconia nanoparticles. In some embodiments, the nanoparticles have a mean diameter in a range from 1 to 200 nm, or 5 to 150 nm, or 5 to 125 nm. In illustrative embodiments, the nanoparticles can be “surface modified” such that the nanoparticles provide a stable dispersion in which the nanoparticles do not agglomerate after standing for a period of time, such as 24 hours, under ambient conditions.

The thickness of the cured hardcoat layer 120 can be any useful thickness. In some embodiments, the cured hardcoat layer 120 has a thickness of 1 to 25 micrometers. In another embodiment, cured hardcoat layer 120 has a thickness of 1 to 15 micrometers. In another embodiment, cured hardcoat layer 120 has a thickness of 1 to 10 micrometers. In another embodiment, cured hardcoat layer 120 has a thickness of 1 to 5 micrometers.

Useful acrylates include, for example, poly(meth)acryl monomers such as, for example, (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing such as, for example, N,N-dimethyl acrylamide; and combinations thereof. Such compounds are widely available from vendors such as, for example, Sartomer Company, Exton, Pa.; UCB Chemicals Corporation, Smyrna, Ga.; and Aldrich Chemical Company, Milwaukee, Wis. Additional useful (meth)acrylate materials include hydantoin moiety-containing poly(meth)acrylates, for example, as described in U.S. Pat. No. 4,262,072 (Wendling et al.).

In an illustrative embodiment, the curable hardcoat layer 120 includes a monomer having at least two or three (meth)acrylate functional groups. Commercially available cross-linkable acrylate monomers include those available from Sartomer Company, Exton, Pa. such as trimethylolpropane triacrylate available under the trade designation “SR351”, pentaerythritol triacrylate available under the trade designation “SR444”, dipentaerythritol triacrylate available under the trade designation “SR399LV”, ethoxylated (3) trimethylolpropane triacrylate available under the trade designation “SR454”, ethoxylated (4) pentaerythritol triacrylate, available under the trade designation “SR494”, tris(2-hydroxyethyl)isocyanurate triacrylate, available under the trade designation “SR368”, and dipropylene glycol diacrylate, available under the trade designation “SR508”.

Useful urethane acrylate monomers include, for example, a hexafunctional urethane acrylate available under the tradename Ebecryl 8301 from Radcure UCB Chemicals, Smyrna, Ga., CN981 and CN981B88 available from Sartomer Company, Exton, Pa., and a difunctional urethane acrylate available under the tradename Ebecryl 8402 from Radcure UCB Chemicals, Smyrna, Ga. In some embodiments the hardcoat layer resin includes both poly(meth)acrylate and polyurethane material, which can be termed a “urethane acrylate.”

In some embodiments, the nanoparticles are inorganic nanoparticles such as, for example, silica, alumina, or zirconia. Nanoparticles can be present in an amount from 10 to 200 parts per 100 parts of hardcoat layer monomer. Silicas for use in the materials of the invention are commercially available from Nalco Chemical Co. (Naperville, Ill.) under the product designation NALCO COLLOIDAL SILICAS. For example, silicas include NALCO products 1040, 1042, 1050, 1060, 2327 and 2329. Zirconia nanoparticles are commercially available from Nalco Chemical Co. (Naperville, Ill.) under the product designation NALCO OOSSOO8.

Surface treating or surface modification of the nano-sized particles can provide a stable dispersion in the hardcoat layer resin. The surface-treatment can stabilize the nanoparticles so that the particles will be well dispersed in the polymerizable resin and result in a substantially homogeneous composition. Furthermore, the nanoparticles can be modified over at least a portion of its surface with a surface treatment agent so that the stabilized particle can copolymerize or react with the polymerizable hardcoat layer resin during curing.

The nanoparticles can be treated with a surface treatment agent. In general a surface treatment agent has a first end that will attach to the particle surface (covalently, ionically or through strong physisorption) and a second end that imparts compatibility of the particle with the hardcoat layer resin and/or reacts with hardcoat layer resin during curing. Examples of surface treatment agents include alcohols, amines, carboxylic acids, sulfonic acids, phospohonic acids, silanes and titanates. The preferred type of treatment agent is determined, in part, by the chemical nature of the inorganic particle or metal oxide particle surface. Silanes are generally preferred for silica and zirconia (the term “zirconia” includes zirconia metal oxide.) The surface modification can be done either subsequent to mixing with the monomers or after mixing.

In some embodiment, it is preferred to react silanes with the particle or nanoparticle surface before incorporation into the resin. The required amount of surface modifier is dependant upon several factors such as particle size, particle type, modifier molecular wt, and modifier type. In general it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for approximately 1-24 hours approximately. Surface treatment agents such as carboxylic acids do not require elevated temperatures or extended time.

Surface modification of zirconia (ZrO₂) with silanes can be accomplished under acidic conditions or basic conditions. In one embodiment, silanes are preferably heated under acid conditions for a suitable period of time. At which time the dispersion is combined with aqueous ammonia (or other base). This method allows removal of the acid counter ion from the ZrO₂ surface as well as reaction with the silane. Then the particles are precipitated from the dispersion and separated from the liquid phase.

The surface modified particles can be incorporated into the curable resin by various methods. In one embodiment, a solvent exchange procedure is utilized whereby the resin is added to the surface modified nanoparticles, followed by removal of the water and co-solvent (if used) via evaporation, thus leaving the particles dispersed in the polyerizable resin. The evaporation step can be accomplished for example, via distillation, rotary evaporation or oven drying, as desired.

Representative embodiments of surface treatment agents suitable for inclusion in the hardcoat layer include compounds such as, for example, phenyltrimethoxysilane, phenyltriethoxysilane, 2-(3,4-epoxycyclohexyl)ethyltriethoxysilane, 2-(3,4-epoxycyclohexyl)ethyltrimethoxysilane, isooctyl trimethoxy-silane, N-(3-triethoxysilylpropyl) methoxyethoxyethoxyethyl carbamate (PEG3TES), Silquest A1230, N-(3-triethoxysilylpropyl) methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures thereof.

A photoinitiator can be included in the hardcoat layer. Examples of initiators include, organic peroxides, azo compounds, quinines, nitro compounds, acyl halides, hydrazones, mercapto compounds, pyrylium compounds, imidazoles, chlorotriazines, benzoin, benzoin alkyl ethers, di-ketones, phenones, and the like. Commercially available photoinitiators include, but not limited to, those available commercially from Ciba Geigy under the trade designations DARACUR 1173, DAROCUR 4265, IRGACURE 651, IRGACURE 184, IRGACURE 1800, IRGACURE 369, IRGACURE 1700, and IRGACURE 907, IRGACURE 819 and from Aceto Corp., Lake Success N.Y., under the trade designations UVI-6976 and UVI-6992. Phenyl-[p-(2-hydroxytetradecyloxy)phenyl]iodonium hexafluoroantomonate is a photoinitiator commercially available from Gelest, Tullytown, Pa. Phosphine oxide derivatives include LUCIRIN TPO, which is 2,4,6-trimethylbenzoy diphenyl phosphine oxide, available from BASF, Charlotte, N.C. In addition, further useful photoinitiators are described in U.S. Pat. Nos. 4,250,311, 3,708,296, 4,069,055, 4,216,288, 5,084,586, 5,124,417, 5,554,664, and 5,672,637. A photoinitiator can be used at a concentration of about 0.1 to 10 weight percent or about 0.1 to 5 weight percent based on the organic portion of the formulation (phr.)

The hardcoat layer 120 described herein can be cured in an inert atmosphere. It has been found that curing the hardcoat layer 120 in an inert atmosphere can assist in providing/maintaining the scratch and stain resistance properties of the hardcoat layer 120. In some embodiments, the hardcoat layer 120 is cured with a UV light source under a nitrogen blanket.

To enhance durability of the hardcoat layer, especially in outdoor environments exposed to sunlight, a variety of commercially available stabilizing chemicals can be added. These stabilizers can be grouped into the following categories: heat stabilizers, UV light stabilizers, and free-radical scavengers. Heat stabilizers are commercially available from Witco Corp., Greenwich, Conn. under the trade designation “Mark V 1923” and Ferro Corp., Polymer Additives Div., Walton Hills, Ohio under the trade designations “Synpron 1163”, “Ferro 1237” and “Ferro 1720”. Such heat stabilizers can be present in amounts ranging from 0.02 to 0.15 weight percent. UV light stabilizers can be present in amounts ranging from 0.1 to 5 weight percent. Benzophenone type UV-absorbers are commercially available from BASF Corp., Parsippany, N.J. under the trade designation “Uvinol 400”; Cytec Industries, West Patterson, N.J. under the trade designation “Cyasorb UV1164” and Ciba Specialty Chemicals, Tarrytown, N.Y., under the trade designations “Tinuvin 900”, “Tinuvin 123” and “Tinuvin 1130”. Free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation “Tinuvin 292” and Cytec Industries under the trade designation “Cyasorb UV3581”

The composite film article 100 can optionally include one or more additional layers. Additional layers can include, for example, a release liner 110, 112 or a surface treatment layer.

The release liner 110, 112 can be formed of any useful material such as, for example, polymers or paper and may include a release coat. Suitable materials for use in release coats are well known and include, but are not limited to, fluoropolymers, acrylics and silicons designed to facilitate the release of the release liner from the cured hardcoat layer 120 and/or the thermoplastic layer 130.

In some embodiments, the release liner 110 has a micro-structured surface (not shown). In these embodiments, the cured hardcoat layer 120 can have a corresponding micro-structured surface. Providing a release liner 110 with a micro-structured surface can allow for a corresponding hardcoat layer 120 micro-structured surface for the purposes of providing a matte finish to the hardcoat layer 120 or for providing the hardcoat layer 120 with other desired optical properties. The microstructures can be any useful microstructure that is disposed in a regular or random pattern across the surface of the release liner (and the corresponding hardcoat layer surface disposed on the micro-structured release liner) and can have micro-structured width and height independently selected from a range of 1 to 1000 micrometers, or 5 to 500 micrometers, or 10 to 100 micrometers. These micro-structures can be formed on the release liner by any useful method such as, for example, embossing or molding of the release liner.

Surface treatments may be useful to secure adhesion between the thermoplastic layer 130 (and/or ink receptor layer) and the cured hardcoat layer 120. Surface treatments include, for example, chemical priming, corona treatment, plasma or flame treatment. A chemical primer layer or a corona treatment layer can be disposed between the thermoplastic layer 130 (and/or ink receptor layer) and the cured hardcoat layer 120. A chemical primer layer or a corona treatment layer can be disposed on one or both the thermoplastic layer 130 (and/or ink receptor layer) and the cured hardcoat layer 120. When a chemical primer layer and/or corona treatment is employed, inter-layer adhesion between the thermoplastic layer 130 (and/or ink receptor layer) and the cured hardcoat layer 120, can be improved.

Suitable chemical primer layers may be selected from urethanes, silicones, epoxy resins, vinyl acetate resins, ethyleneimines, and the like. Examples of chemical primers for vinyl and polyethylene terephthalate films include crosslinked acrylic ester/acrylic acid copolymers disclosed in U.S. Pat. No. 3,578,622. The thickness of the chemical primer layer is suitably within the range of 10 to 3,000 nanometers (nm).

Corona treatment is a useful physical priming suitably applied to the cured hardcoat layer 120 onto which is then coated the thermoplastic layer 130 (and/or ink receptor layer). Corona treatment (or coating an additional prime layer) can improve the inter-layer adhesion between the thermoplastic layer 130 and the cured hardcoat layer 120.

The transparent cured hardcoat composite film described above can be used to protect a graphic substrate by removing one or more of the release liners and laminating the transparent cured hardcoat composite film onto a graphic substrate with heat and pressure. The thermoplastic layer or ink receptive layer softens with the application of heat and adheres to the graphic substrate to form a protected graphic substrate.

FIG. 2 illustrates one embodiment of a protected graphic substrate 200. As described above, the transparent cured hardcoat composite film 201 includes a stain and scratch resistant cured hardcoat layer 220 disposed on a thermoplastic layer 230. In many embodiments, the thermoplastic layer 230 includes an ink receptive material or an ink receptive layer. In some embodiments, the thermoplastic layer 230 is an ink receptive thermoplastic layer. In some embodiments, an image is disposed on either side of the thermoplastic layer 230. The thermoplastic layer 230 is adhered to a graphic substrate 250 via heat and pressure lamination.

The graphic substrate 250 can be formed from any suitable graphic material. In many embodiments, the graphic substrate 250 is a conformable material such as, for example, a polymer film. In some embodiments, the graphic substrate 250 is a vinyl film such as, for example, a polyvinyl chloride film. In some embodiments, the graphic substrate 250 includes an image disposed on or in the graphic substrate 250. In some embodiments, the graphic substrate 250 may contain colorants to provide a uniform background colored film.

In many embodiments, an adhesive such as, for example, a pressure sensitive adhesive can be disposed on the graphic substrate 250 for application to a display substrate. Illustrative display substrates includes for example, building surfaces, vehicle surfaces or other graphic display surfaces.

The present invention should not be considered limited to the particular examples described herein, but rather should be understood to cover all aspects of the invention as fairly set out in the attached claims. Various modifications, equivalent processes, as well as numerous structures to which the present invention can be applicable will be readily apparent to those of skill in the art to which the present invention is directed upon review of the instant specification.

### EXAMPLES

Articles of Examples 1-6 and Comparative Examples C1-C2 were prepared as detailed below. Elongation (%), stain resistance and scratch resistance were measured and are provided in Table 1.

The hardcoat composite film article of Example 1 was prepared by combining 50.0 parts PETA (pentaerythritol tetraacrylate—SR295—Sartomer Company, Inc), 50.0 parts HDODA (1,6-hexanediol diacrylate—SR238—Sartomer Company, Inc), 6.0 parts Tinuvin 928 (UVA—Ciba Chemical Corporation, Tarrytown N.Y.), 1.0 parts Irgacure 819 (PI —Ciba Chemical Corporation, Tarrytown N.Y.), 0.5 parts Tinuvin 123 (HALS—Ciba Chemical Corporation, Tarrytown N.Y.) and 0.5 parts Ebecryl 350 (UBC Chemical Corp. Smyma, Ga.). The components were thoroughly admixed and heated until all components were in solution. The resultant hardcoat solution was coated onto polyethylene (PE) film on an adhesive coated liner using a #3 wire wound bar (R.D.S. Webster N.Y.). The coated film was placed on a metal plate and cured with an UV light through the hardcoat layer by irradiation with a Fusion D lamp (Fusion Systems Corp., Rockville, Md.) set at 100% power and using nitrogen inerting sufficient to bring the oxygen level below 100 ppm. The web speed was 25 feet per minute (7.6 meters per minute). The cured film was then corona treated in an air atmosphere using an Eni Power Systems Model RS-8 Surface Treater (Eni Power Systems, Rochester, N.Y.) at a setting of 500 Watts at 10 feet per minute (3 meters per minute). The corona treated film was coated with 3M™ 94 Tape Primer (3M Company) using a #6 wire wound bar (R.D.S., Webster, N.Y.) and dried in a 150 degree F. (65 degree C.) oven for 1 minute. The primer coated film was then coated with a resin solution formed by thoroughly mixing 10.0 wt-% Paraloid B-82 acrylic resin (Rohm and Haas Co., Philadelphia, Pa.) and 90.0 wt-% 3M™ Thinner CGS-10 (3M Company). This resin solution was coated onto the primer coated film using a #6 wire wound bar and dried in a 150 degree F. (65 degree C.) oven for one minute. The resultant composite film article was then placed face to face with a sheet of 3M™ Controltac™ Plus Graphic Film Series 180-10 (2 mil thick white vinyl film; “180 Vinyl Film”; 3M Company) and run through an Orca 1 Laminator (Pro Tech Engineering, Madison, Wis.) at 2 feet per minute (0.61 meters per minute) and a nip pressure of 50 psi (345 kPa). The laminator top roll temperature was 225 degrees F. (107 degree C.) and the bottom roll temperature was set at 36 degree F. (2.2 degree C.) the temperature was variable, since no cooling was provided). The resultant laminated construction was allowed to cool to ambient temperature. After removal of the PE film, the 180 Vinyl Film with hardcoat thereon was ready for transfer to a display substrate.

The hardcoat composite film article of Example 2 was prepared as described for Example 1, except that a UV crosslinked acrylic coated paper was used instead of the PE film on an adhesive coated liner. The acrylic coating had a surface tension of 30 dynes per cm² After removal of the UV crosslinked acrylic coated paper, the 180 Vinyl Film with hardcoat thereon was ready for transfer to a display substrate.

The composite film article of Example 3 was prepared as described for Example 2, except without the Paraloid B-82 acrylic resin solution coating step. 180 Vinyl Film was coated with Paraloid B-82 acrylic resin solution prepared as described in Example 1 using a #6 wire wound bar and drying the film at 150 degrees F. (65 degrees C.) for 1 minute. The primed surface of the hardcoat on the acrylic coated paper liner was laminated to the acrylic resin surface on 180 Vinyl Film using the lamination process described in Example 1. The resultant laminated construction was allowed to cool to ambient temperature. After removal of the acrylic coated paper liner, the 180 Vinyl Film with hardcoat thereon was ready for transfer to a substrate.

The hardcoat composite film article of Example 4 was prepared by coating the hardcoat solution described in Example 1 onto acrylic coated paper and curing and corona treating the coating as described for Example 1. 3M™ SCPM 19 premask film (3M Company) was laminated to the hardcoat and the acrylic coated paper removed. The hardcoat surface was then coated with a primer, the primer dried, the primer coated with the acrylic resin solution and dried as described in Example 1. The resultant composite film was then laminated to 180 Vinyl Film using the heat lamination procedure and conditions described in Example 1. The resultant laminated construction was allowed to cool to ambient temperature and the premask removed.

The hardcoat composite film article of Example 5 was prepared by coating the hardcoat solution described in Example 1 onto acrylic coated paper and curing and corona treating the coating as described for Example 2. The coating was corona treated, a primer was applied and dried and the acrylic resin solution applied and dried as described in Example 1. The resultant composite film was printed with 3M Screen printing Ink 1905 black and dried for 1 hour at 150 degree F. (65 degree C.). The printed film was then laminated to 180 Vinyl Film using the heat lamination procedure and conditions described in Example 1. The acrylic coated paper was removed, providing a hardcoated printed vinyl article.

The hardcoat composite film article of Example 6 was prepared by coating the hardcoat solution described in Example 1 onto acrylic coated paper and curing and corona treating the coating as described for Example 2. A primer was applied and dried and the acrylic resin solution applied and dried as described in Example 1. A print receptor coating (WF 55-034 Stahl USA Peabody Mass. coated with a #6 bar) was then applied to the hardcoat and dried for 30 minutes at 150 degree F. (65 degree C.). Using standard print conditions, a Vutek 2360 printer was used to print on the print receptive coating. The article was then transferred to 180 Vinyl Film using the process outlined above. The acrylic coated paper was removed, providing a hardcoated printed vinyl article.

Comparative Example 1 (C1) was the 180 Vinyl Film as commercially available from 3M Company. The film was not coated with a hardcoat composition.

The hardcoat composite film article of Comparative Example 2 (C2) was prepared by coating the hardcoat solution described in Example 1 directly on 180 Vinyl Film instead of PE film on an adhesive coated liner and then cured as described for Example 1 while on the 180 Vinyl Film.

Elongation tests were carried out by fixing a six inch long one inch wide strip of the sample in an Instron tensile tester Model No. 5564 (Canton, Mass.) and stretching at a rate of 12 inches per minute (0.3 meters per minute) according to ASTM 3759. Elongation at break was measured. The average of three readings per sample are provided in Table 1.

Samples of each Example and Comparative Example in Table 1 were prepared for Stain Resistance testing by using overlapping strokes of a red BEIFA® PY1006 Permanent Marker (Ningo Beifa Group Co. Ltd, China) to provide a uniform stain across an approximate 2 inch (51 mm) square area of the sample. The sample was heated in a 65 degree C. oven for about 30 minutes. The sample was removed from the oven, allowed to cool to ambient temperature and the stained area wiped with an isopropyl alcohol soaked white towel to remove as much stain as possible. Wiping with alcohol was continued until the towel showed no additional stain removal. The sample was placed in the Gretag Macbeth Color-Eye 7000A (New Windsor, N.Y.) instrument using ProPalette software. The color difference between the area of the sample that was stained and an area that was not stained was measured and the Delta E* values provided in Table 1.

Oscillating Sand Abrasion Test (OST % Gloss Loss) was performed on the coated cured composite film articles using a modification to the procedure described in ASTM F735. The major modification consisted of using 50 grams of weight and abrading the sample for 60 minutes. 60 Degree gloss measurements were taken before and after the test and a percent gloss loss was recorded. The equipment used for this test was a linear oscillating shaker manufactured by Arthur H Thomas Co. Philadelphia, Pa. Scratch resistance was measured (% Gloss Loss) and the average of six measurements on one sample are provided in Table 1.

TABLE 1

| | Stain | | |
|---|---|---|---|
| | Resistance | Elongation | Scratch Resistance |
| Example No. | (Delta E*) | (%) | (% Gloss Loss) |
| 1 | 5.04 | 137 | 8.9 |
| 2 | 2.61 | 59 | 8.5 |
| 3 | 10.1 | 169 | 0.4 |
| 4 | 2.50 | 154 | 1.1 |
| 5 | 3.41 | 53 | 0 |
| 6 | 5.10 | 196 | 8.7 |
| C1 | 69.1 | 145 | 90 |
| C2 | 1.89 | 23 | 7.4 |

The data in Table 1 illustrate, for example, that by coating and curing the hardcoat on a release liner and then transferring this hardcoat, the vinyl/hardcoat composite film article preserves the elongation values of the vinyl film, thus making removal of the hardcoated vinyl film from a substrate easier than a hardcoat that was cured while on the vinyl film.

We claim:

1. A method of protecting a graphic substrate comprising:
coating a hardcoat composition onto a substrate to form a hardcoat layer;
curing the hardcoat layer to form a cured hardcoat layer;
disposing a thermoplastic layer onto the cured hardcoat layer to form a transparent hardcoat composite film;
laminating the transparent hardcoat composite film onto a graphic substrate with heat and pressure, wherein the thermoplastic layer softens and adheres to the graphic substrate to form a protected graphic substrate.

2. A method according to claim 1 further comprising removing the substrate from the transparent hardcoat composite film after the laminating step.

3. A method according to claim 1 wherein the disposing step comprises disposing a thermoplastic layer comprising an ink receptor material onto the cured hardcoat layer to form a transparent hardcoat composite film.

4. A method according to claim 3 further comprising printing a graphic onto the thermoplastic layer before the laminating step.

5. A method according to claim 3 further comprising printing a graphic onto the thermoplastic layer, with a solvent based ink, before the laminating step

6. A method according to claim 1 wherein the curing step comprises curing the hardcoat layer to form a cured hardcoat layer having a thickness in a range from 1 to 15 micrometers; and the disposing step comprises disposing a thermoplastic layer, having a thickness in a range from 0.5 to 5 micrometers onto the cured hardcoat layer to form a transparent hardcoat composite film having a thickness in a range from 1.5 to 20 micrometers.

7. A method according to claim 1 wherein the substrate is a release liner.

8. A method of protecting a graphic substrate comprising:
providing a transparent cured hardcoat composite film having a cured hardcoat layer on a thermoplastic layer, the cured hardcoat layer having a thickness in a range from 1 to 15 micrometers and the thermoplastic layer having a thickness in a range from 0.5 to 5 micrometers;
printing an image onto the thermoplastic layer; and
laminating the transparent hardcoat composite film onto a graphic substrate with heat and pressure, wherein the thermoplastic layer softens and adheres to the graphic substrate to form a protected graphic substrate.

9. A method according to claim 8 wherein the providing step comprises providing a transparent cured hardcoat composite film having a cured hardcoat layer on a thermoplastic layer and a release liner disposed on the cured hardcoat layer.

10. A method according to claim 8 wherein the printing step comprises printing a graphic onto the thermoplastic layer with a solvent based ink before the laminating step.

11. A method according to claim 8 wherein the printing step comprises printing a graphic onto the thermoplastic layer with thermal mass transfer before the laminating step.

12. A transparent cured hardcoat composite film comprising:
a release liner;
a stain and scratch resistant cured hardcoat layer disposed on the release liner, the cured hardcoat layer having a thickness in a range from 1 to 15 micrometers; and
a thermoplastic layer on the cured hardcoat layer, the thermoplastic layer having a thickness in a range from 0.5 to 20 micrometers.

13. A film according to claim 12 wherein the thermoplastic layer further comprises an ink receptive material forming an ink receptive thermoplastic material.

14. A film according to claim 12 wherein the thermoplastic layer has a thickness in a range from 0.5 to 5 micrometers.

15. A film according to claim 13 further comprising a graphic printed on the thermoplastic layer.

16. A film according to claim 15 wherein the graphic is disposed between the ink receptive thermoplastic layer and the cured hardcoat layer.

17. A film according to claim 15 wherein the ink receptive thermoplastic layer is disposed between the graphic and the cured hardcoat layer.

18. A film according to claim 13 wherein the graphic is formed from a solvent based ink.

19. A film according to claim 12 wherein the cured hardcoat layer comprises a cross-linked multi-functional polyacrylate and a polyurethane.

20. A film according to claim 12 wherein the ink receptive thermoplastic layer comprises a polyacrylate.

21. A film according to claim 12 wherein the release liner has a micro-structured surface and the cured hardcoat layer has a corresponding micro-structured surface.
